(19) United States
(12) Patent Application Publication
(10) Pub. No.: US 2014/0201369 A1
(43) Pub. Date: Jul. 17, 2014

(54) INFORMATION MANAGEMENT DEVICE, INFORMATION MANAGEMENT PROGRAM, AND INFORMATION MANAGEMENT METHOD

(71) Applicants: Naoki Maeda, Nara-shi (JP); Kazuki Kasai, Kyoto (JP)

(72) Inventors: Naoki Maeda, Nara-shi (JP); Kazuki Kasai, Kyoto (JP)

(73) Assignee: OMRON CORPORATION, Kyoto-shi, Kyoto (JP)

(21) Appl. No.: 14/238,533

(22) PCT Filed: Jul. 25, 2012
(86) PCT No.: PCT/JP2012/068771

§ 371 Date: Feb. 12, 2014

(30) Foreign Application Priority Data
Aug. 12, 2011 (JP) 2011-176584
Jan. 13, 2012 (JP) 2012-005237

(51) Int. Cl. H04L 12/24

(52) U.S. Cl. CPC H04L 41/5041
USPC 709/225

(57) ABSTRACT

By determining whether or not sensing data provided from an information provision device is appropriate with respect to the specifications previously determined for the sensing data and thus preventing the breach of a contract concerning a provision of the sensing data and the breach of a contract concerning use of the sensing data, reliability of the sensing data from the perspective of a user who uses the sensing data can be improved. An information management device (1) stores, in a provider contract DB (13), specifications of information (sensing data) provided from the information provision device (2) connected in a communicable manner through a network (5). The information management device (1), in a determination unit (33), determines whether or not the information provided from the information provision device (2) is appropriate with respect to the specifications of the information stored in the provider contract DB (13) and stores the determination result in a provision information specifications management table (18).

### CROSS-REFERENCE TO RELATED APPLICATIONS

The present application is a national stage application of PCT/JP2012/068771 filed Jul. 25, 2012, which claims priority to Japanese Patent Application No. JP2011-176584, filed Aug. 12, 2011, and Japanese Patent Application No. JP2012-005237, filed Jan. 13, 2012. The priority applications are hereby incorporated by reference in their entirety.

### TECHNICAL FIELD

The present invention relates to an information management device, an information management program, and an information management method that manage sensing data provided from an information provision device connected in a communicable manner through a network.

### BACKGROUND ART

Conventionally, a system has been proposed, the system in which an information provision device uploads information (sensing data) acquired by a sensor to an information management device (center), and an information use device downloads and uses the information (sensing data the information provision device has uploaded) from the information management device (see Patent Literature 1, for example).

In this system, a manager who manages and administers an information management device exchanges a contract (provision contract) concerning a provision of information with a provider (manager of an information provision device, or the like). The manager also exchanges a contract (use contract) concerning use of information with a user (manager of an information use device, or the like).

In the provision contract, the manager determines with the provider the content of a plurality of items such as a type of information to be provided, specifications of information to be provided, and an amount of consideration (use fee) to be charged for use of information to be provided. In the use contract, the manager determines with the user the content of a plurality of items such as a type of information to be used, the specifications of information to be used, and an amount of consideration (use fee) to be paid for use of information.

The specifications of information are values for each item that indicates the characteristic of the information, for example, if information is an image, the specifications are values concerning a pixel size (the number of vertical pixels x the number of horizontal pixels), the number of pixel bits, a light receiving dynamic range width, and the like. Likewise, if information is temperature measured by a temperature sensor, humidity measured by a humidity sensor, or illuminance measured by an illuminance sensor, the specifications of information are values concerning the number of bits of data as resolution of such a measured value.

The information management device, based on the provision contract and the use contract, performs delivery and receipt of information (relay of information) between the information provision device and the information use device.

### CITATION LIST

### Patent Literature

Patent Literature 1: Japanese Patent Laid-Open Publication No. 2005-321934

### SUMMARY OF THE INVENTION

### Technical Problem

However, the information provided from the information provision device may be in an inappropriate status in which the specifications determined in the provision contract are not satisfied for some reason. When recognizing that the information provided from the information provision device is in the inappropriate status in which the specifications are not satisfied, a provider confirms the status of the information provision device and deals with the reason. Thus, as the time period from when the information provided from the information provision device is in an inappropriate status in which the specifications are not satisfied until when the provider recognizes the status becomes longer, the time period when inappropriate information that does not satisfy the specifications is provided from the information provision device becomes longer.

In addition, the information management device, even though the information provided from the information provision device is inappropriate with respect to the specifications determined by the contract, transmits the information to the information use device, treating the information as information provided in the specifications determined by the provision contract. In other words, the information is provided to the user of the information use device in a state in which the use contract is not observed (state in which the contract cannot be fulfilled). Moreover, the user uses the information that is not appropriate with respect to the specifications determined by the contract, thereby possibly ending up making a wrong assessment from the result of use of the information.

With delayed realization that the information provided from the information provision device is inappropriate with respect to the specifications determined by the contract, the breach of the use contract to the user of the information use device continues until the delay is realized.

An object of the present invention is to provide an information management device, an information management program, and an information management method capable of improving reliability of sensing data from the perspective of a user who uses sensing data by determining whether or not the sensing data provided from an information provision device is appropriate with respect to the specifications previously determined for the sensing data and thus preventing the breach of a contract concerning a provision of the sensing data and the breach of a contract concerning use of the sensing data.

### Solution to Problem

In order to solve the above described problem and achieve the forgoing object, an information management device according to the present invention is configured as follows.

A provision information storage unit stores sensing data (information) provided from an information provision device connected in a communicable manner through a network. An information selection unit, when receiving a use request of the sensing data from an information use device connected in a communicable manner through the network, selects the sensing data corresponding to the use request from the sensing data stored in the provision information storage unit. A determination unit determines whether or not the sensing data provided from the information provision device is appropriate with respect to specifications predetermined for the sensing data. The specifications of sensing data may be determined by a type of the sensing data to be provided. For example, in a case in which the information provision device provides as sensing data an image imaged by an image sensor, values concerning a pixel size (the number of vertical pixels×the number of horizontal pixels), the number of pixel bits, a light receiving dynamic range width, and the like may be set as the specifications of sensing data. Alternatively, in a case in which the information provision device provides as sensing data temperature measured by a temperature sensor, humidity measured by a humidity sensor, or illuminance measured by an illuminance sensor, the number of bits of data as resolution of a measured value may be set as the specifications of sensing data.

For example, the determination unit, regarding an item stored as the specifications of the sensing data provided from the information provision device, may preferably sense a value in the sensing data. For example, the determination unit, if sensing data is an image, senses a pixel size (the number of vertical pixels×the number of horizontal pixels) and the number of pixel bits. In addition, the determination unit may preferably sense, if sensing data is temperature measured by a temperature sensor, humidity measured by a humidity sensor, or illuminance measured by an illuminance sensor, the number of bits of temperature data, humidity data, or illuminance data. Then, the determination unit, for each item, may preferably compare the sensed value and predetermined specifications and may preferably determine whether or not the provided sensing data is appropriate with respect to the predetermined specifications of the information stored in the provision side specifications storage unit.

Moreover, the determination unit may be configured to make a comparison between sensing data being provided at a point of time and sensing data that has been provided in a past and to determine, based on a difference by the comparison, whether or not the sensing data being provided at the point of time is appropriate.

Furthermore, the determination unit, in a case in which information is image data, may be configured to compare the information and sensing data provided from another information provision device that has approximately the same specifications and to determine, regarding items such as alight receiving dynamic range width, whether or not the provided sensing data is appropriate. A determination result storage unit stores a determination result of the determination unit. A provision contract information storage unit stores provision contract information that indicates content of a provision contract including at least a sensing range and a type of the sensing data to be provided, the provision contract being exchanged regarding use of the sensing data to be provided from the information provision device. A use contract information storage unit stores use contract information that indicates content of a use contract including at least a sensing range and a type of the sensing data to be used, the use contract being exchanged regarding use of the sensing data in the information use device.

The information selection unit, by using the provision contract information and the use contract information, selects the sensing data corresponding to a received use request, and does not select, as the sensing data corresponding to the use request, the sensing data of which the determination result is stored in the determination result storage unit as inappropriate with respect to the predetermined specifications.

This can prevent a user who uses sensing data from transmitting the sensing data that is not appropriate with respect to the predetermined specifications. Thus, this configuration can further prevent a user from using the sensing data of which the specifications are not appropriate and can improve reliability of the sensing data from the perspective of a user.

In addition, the information selection unit may preferably be configured to select the sensing data corresponding to a use request received from the information use device, using provision contract information and use contract information, for example. The provision contract information indicates content of a provision contract exchanged regarding use of provision information to be provided from the information provision device, and the use contract information indicates the content of a use contract exchanged regarding use of use information in the information use device.

### Advantageous Effects of Invention

The present invention thus makes it possible to prevent the breach of a contract concerning a provision of sensing data and the breach of a contract concerning use of sensing data and also to improve reliability of the sensing data from the perspective of a user who uses sensing data.

### BRIEF DESCRIPTION OF DRAWINGS

FIG. 1 is a block diagram illustrating a schematic configuration of a network system.

FIG. 2 is a block diagram illustrating a configuration of a main part of an information management device.

FIG. 3 is a view illustrating a configuration of a provider contract DB.

FIG. 4 is a view illustrating a configuration of a user contract DB.

FIG. 5 is a view illustrating a configuration of a management information DB.

FIG. 6 is a view illustrating a configuration of an information storage DB.

FIG. 7 is a view illustrating a configuration of a use history DB.

FIG. 8 is a view illustrating a configuration of a provision information specifications management table.

FIG. 9 is a functional block diagram illustrating a functional configuration of the information management device.

FIG. 10 is a flowchart illustrating a reception process of information provided from the information provision device.

FIG. 11 is a flowchart illustrating an information provision process in which information is provided to an information use device.

FIG. 12 is a block diagram illustrating a configuration of a main part of an information management device according to another example of the present invention.

FIG. 13 is a view illustrating a configuration of a provider contract DB according to another example of the present invention.

FIG. 14 is a view illustrating a configuration of a user contract DB according to another example of the present invention.

FIG. 15 is a flowchart illustrating an appropriateness assessment process in the information management device.

FIG. 16 is a flowchart illustrating an alternative availability assessment process in the information management device.

### DESCRIPTION OF EMBODIMENTS

Hereinafter, description will be made of an information management device according to a preferred embodiment of the present invention.

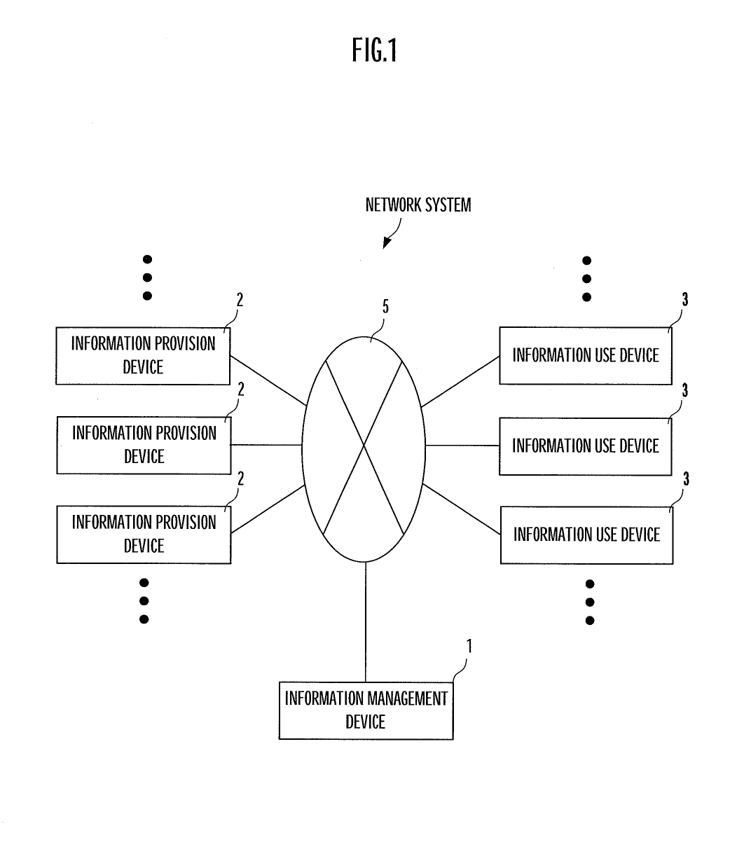

FIG. 1 is a block diagram illustrating a schematic configuration of a network system using the information management device as the preferred embodiment of the present invention. This network system is equipped with an information management device 1, a plurality of information provision devices 2, and a plurality of information use devices 3. The information management device 1, the information provision device 2, and the information use device 3 are connected in a communicable manner through a network 5.

The information provision device 2 is not a specific kind of device, but, for example, a monitoring camera or an air conditioning control system, that is, equipment having one or more sensors (an image sensor, a temperature sensor, a humidity sensor, an illuminance sensor, etc.) that acquire (do sensing) some information (which is equivalent to the sensing data defined by the present invention), such as an image, temperature, humidity, and illuminance. In addition, the information provision device 2 may be configured to perform a predetermined process by using the information (information acquired by the sensor) to be provided to the information management device 1 or may be configured not to use the information in the own device. The information provision device 2 may be equipped with at least a configuration in which the information acquired by the sensor is provided (uploaded) to the information management device 1. Moreover, a person who operates and manages the information provision device 2 (hereinafter referred to as the provider) can restrict the use of information to be provided to the information management device 1 according to a type of a usable application program (hereinafter simply referred to as the application), attribute (an individual, a corporation, etc.), and so on.

The information use device 3 is an information processing device such as a personal computer, a mobile phone, etc. that a user using the information that the information provision device 2 provides possesses. The information use device 3 requests to the information management device 1 the use of the information that the information provision device 2 has provided to the information management device 1. The information use device 3 receives (downloads) the information which the information management device 1 has transmitted corresponding to this request (information use request). On the information use device 3, an application program (hereinafter simply referred to as the application) using the information that the information provision device 2 provides is installed.

The information management device 1 manages: provider contract information based on a contract, exchanged with a provider, concerning a provision of the information from the information provision device 2; user contract information based on a contract, exchanged with a user, concerning use of the information in the information use device 3; and the like. In addition, the information management device 1, based on the provider contract information and the user contract information, manages the specifications and the like of information provided from the information provision device 2 and manages information to be provided to the information use device 3. The information management device 1 performs information management and information relay, between the information provision device 2 that provides information and the information use device 3 that uses the provided information.

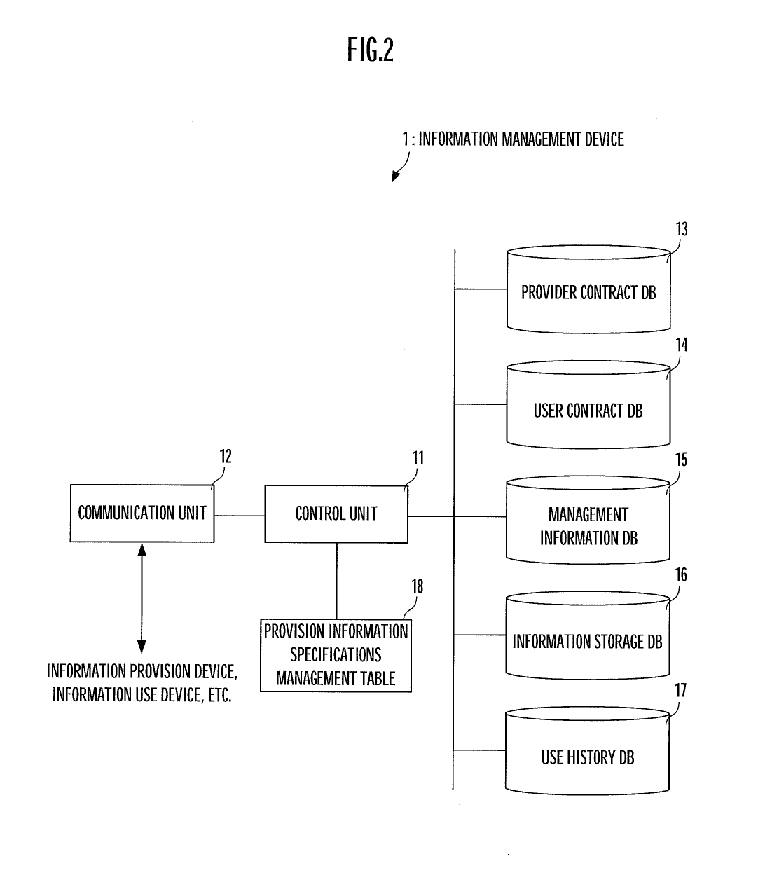

Subsequently, the configuration of this information management device 1 will be described below. FIG. 2 is a block diagram illustrating a configuration of a main part of the information management device. The information management device 1 is equipped with a control unit 11, a communication unit 12, a provider contract database 13 (provider contract DB 13), a user contract database 14 (user contract DB 14), a management information database 15 (management information DB 15), an information storage database 16 (information storage DB 16), a use history database 17 (use history DB 17), and a provision information specifications management table 18.

The control unit 11 controls the operation of the main body of the information management device 1.

The communication unit 12, through the network 5, performs communication with the information provision device 2, the information use device 3, or the like. The communication unit 12 also has a function of designating a destination address and transmitting email.

The provider contract DB 13 registers therein the content of the contract concerning a provision of information exchanged with a provider.

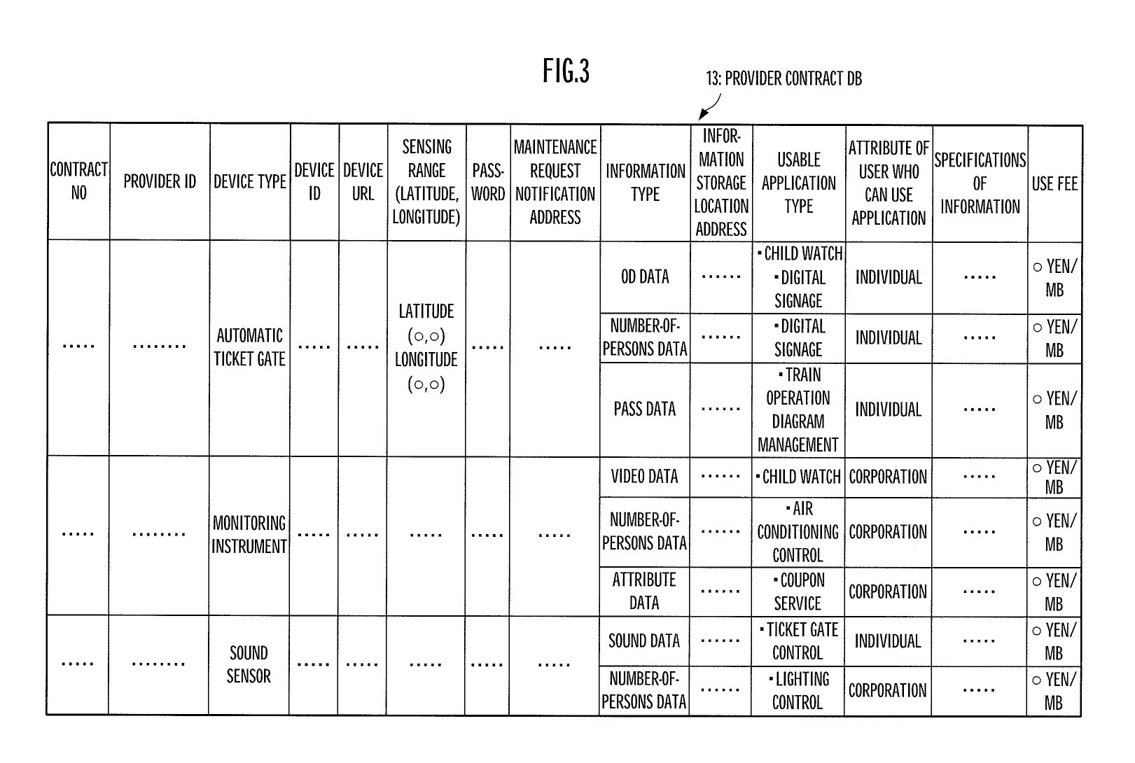

FIG. 3 is a schematic view illustrating the configuration of the provider contract DB. The provider contract DB 13 registers therein, for each contract (provision contract) concerning a provision of information with a provider, a record in which a contract number (contract No), a provider ID, a device type, a device ID, a device URL, a sensing range, a password, a maintenance request notification address, an information type, an information storage location address, a usable application type, an attribute of a user who can use an application, specifications of information, and a use fee are associated with one another.

The contract number is a unique number given individually to each provision contract concerning a provision of information with a provider. The provider ID identifies the provider. The device type is a type of the information provision device 2 that acquires information to be provided, for example, a monitoring camera, an automatic ticket gate, an air conditioning control system, and the like. The device ID identifies this device (information provision device 2). The device URL is a URL (Uniform Resource Locator) of this device.

The sensing range shows a range in which information provided by the information provision device 2 is acquired. This preferred embodiment exemplifies a case in which this range is registered with latitude and longitude. For example, in the case in which the information is an image imaged by a fixed camera, the sensing range is shown with latitude and longitude that show the center of the imaged image.

It is to be noted that the information provision device 2, since a sensing range is not fixed in an image imaged by a mobile terminal with a camera such as a mobile phone, may be configured to sense a location of a terminal body by a GPS (Global Positioning System) function added to the mobile terminal, and to calculate a sensing range by using an inclination of the terminal body sensed by a gyroscope function added to this mobile terminal, an imaging magnification (focal length), and so on. In such a case, while the column of the sensing range is left blank, the information provision device 2 may be configured to transmit (upload) the sensing range together with the information when providing information to the information management device 1.

The password, when the change and updating of this provision contract is performed, is a character string that an operator inputs in order to identify the operator as the provider. The password is set by the provider at the time of the contract.

The maintenance request notification address is a mail address designated by the provider, and is a transmission destination (destination address) of mail concerning a maintenance request and the like with respect to the information provision device 2. In other words, the maintenance request notification address is the contact destination of the provider. The maintenance request is made when information is not provided, when the provided information is inappropriate with respect to the predetermined specifications, or the like.

The information type is a type of information provided from the information provision device 2, and shows: information (raw data) that the information provision device 2 has acquired, such as video data, sound data, and the like; and processed data (metadata) obtained by processing the raw data that the information provision device 2 has acquired, such as OD data, number-of-persons data, and attribute data (attribute data indicating an adult, a child, a female, a male, and so on).

The information storage location address shows an address on a storage medium (information storage DB 16 to be described below) that stores and saves information provided from the information provision device 2.

The usable application type shows the type of an application that is permitted for the use of information. In addition, the attribute of a user who can use an application shows the attribute (an individual, a corporation, etc.) of a user who is permitted for the use of information. This usable application type and the attribute of a user who can use an application are included in information use restrictions that the provider has set at the time of the contract. Moreover, in this preferred embodiment, while a type of an application and an attribute of a user that are permitted for use are registered as a use restriction, a type of an application and an attribute of a user that are not permitted for use may be registered.

The specifications of information are set based on the specifications of the information provided from the information provision device 2, in other words, the performance of the sensor with which the information provision device 2 is equipped in order to acquire information. Furthermore, the specifications of information include an item determined by a type of information to be provided. For example, in a case in which the information provision device 2 provides as information an image imaged by an image sensor, values concerning a pixel size (the number of vertical pixels×the number of horizontal pixels), the number of pixel bits, a light receiving dynamic range width, and the like are the specifications of information. Alternatively, in a case in which the information provision device 2 provides, as information, temperature measured by a temperature sensor, humidity measured by a humidity sensor, or illuminance measured by an illuminance sensor, the number of bits of data as resolution of a measured value is the specifications of sensing data.

The use fee is the amount charged to the user who has used the information. In FIG. 3, while the fee per MB is shown, the fee may be a fee per single use or may be determined in other forms. This use fee is also determined by the provider at the time of the contract.

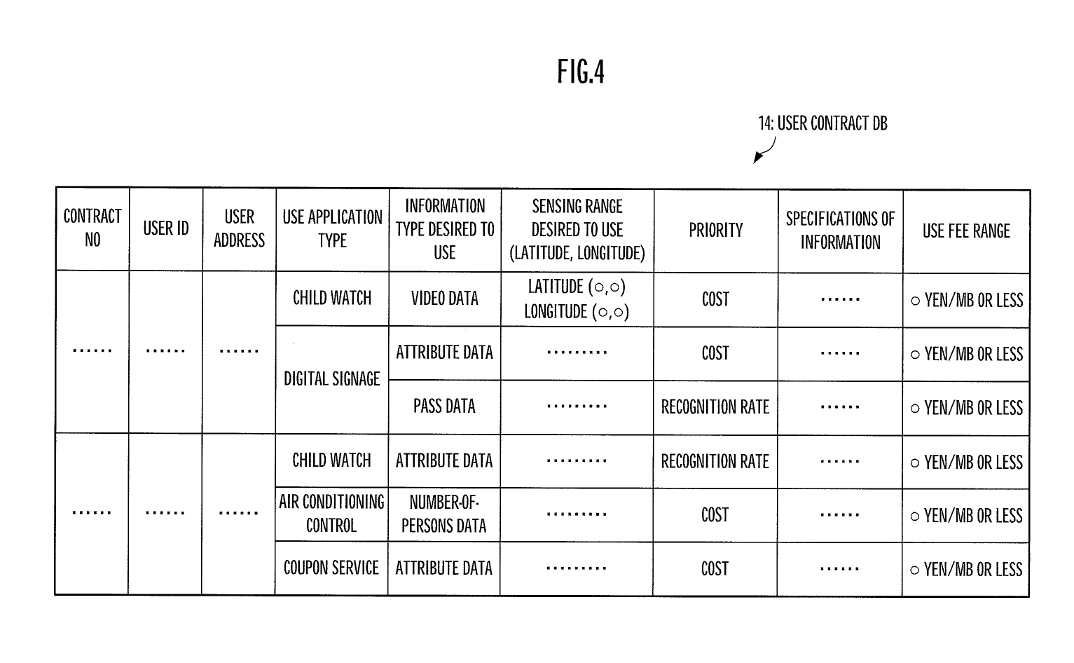

The user contract DB 14 registers therein the content of the contract concerning use of the information exchanged with a user. FIG. 4 is a schematic view illustrating the configuration of the user contract DB. The user contract DB 14 registers therein, for each contract (use contract) concerning a provision of information with a user, a record in which a contract number (contract No), a user ID, a user address, a use application type, an information type desired to be used, a sensing range desired to be used, a priority, specifications of information, and a use fee range are associated with one another.

The contract number is a unique number individually given to a use contract concerning a provision of information with a user. The user ID identifies the user. The user address is a mail address designated by a user. The use application type is a type of an application for which the user uses the provided information. The information type desired to be used shows the type of information to be used.

The sensing range desired to be used shows the range in which information to be used is acquired. In this preferred embodiment, the center of this range is registered with latitude and longitude.

The priority shows, at the use of information, whether cost (fee) is given priority or specifications of information are given priority. The specifications of information define the lower limit of a specifications value of the information to be used. The use fee range defines the upper limit of the fee of information to be used. The use application type, the information type desired to be used, the sensing range desired to be used, the priority, the specifications of information, and the use fee range are decided by the user at the time of the contract.

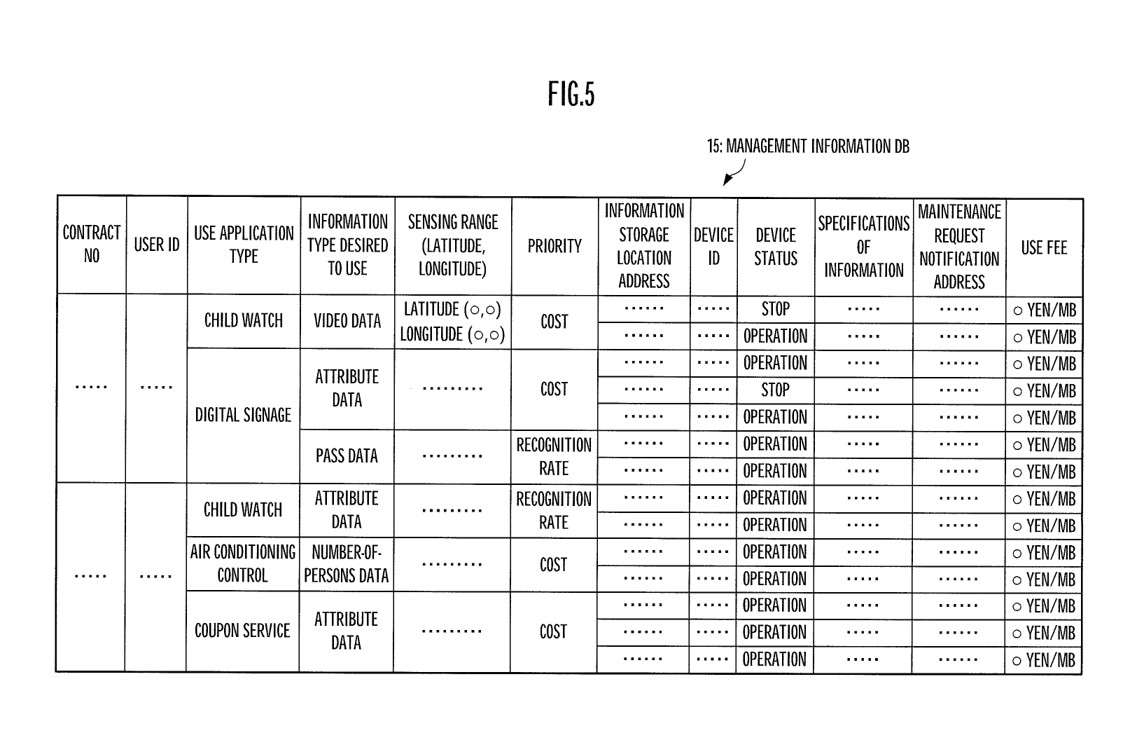

The management information DB 15 is generated based on the content of registration of the provider contract DB 13 and the user contract DB 14 that have been described above. FIG. 5 is a schematic view illustrating the configuration of the management information DB. This management information DB 15 registers therein, for each user, a record in which a contract No (contract number of a user), a user ID, a use application type, an information type desired to be used, a sensing range, a priority, an information storage location address, a device ID, a device status, specifications of information, a maintenance request notification address, and a use fee are associated with one another. The control unit 11, at a predetermined timing (at midnight every day, for example), generates this management information DB 15 based on the content of registration of the provider contract DB 13 and the user contract DB 14 that have been described above. Accordingly, the management information DB 15 reflects an update of the provider contract DB 13 and the user contract DB 14 at the predetermined timing.

It should be noted that this management information DB 15 includes device status information. This information shows a response result set after a response request is transmitted to the relevant information provision device 2 and is confirmed with: responded (operation) and not responded (stop).

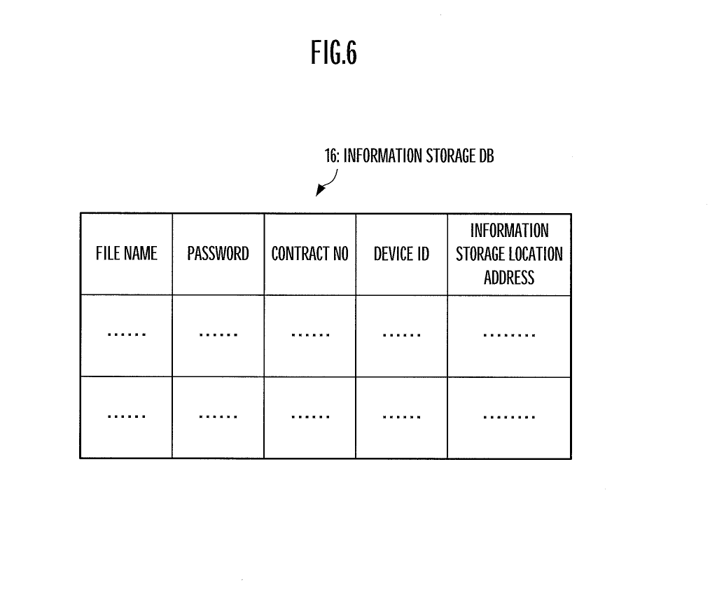

The information storage DB 16 is the database that stores and manages the information provided from the information provision device 2. FIG. 6 is a schematic view illustrating the configuration of an index part of the information storage DB. The information storage DB 16 registers therein a record in which a file name, a password, a contract No (contract number of a provider), a provider ID, and an information storage location address are associated with one another. The file name is the file name given to the information to be provided from the information provision device 2. The password, the contract No (contract number of a provider), the provider ID, and the information storage location address are also registered in the provider contract DB 13. This information storage DB 16 is equivalent to the provision information storage unit defined by the present invention.

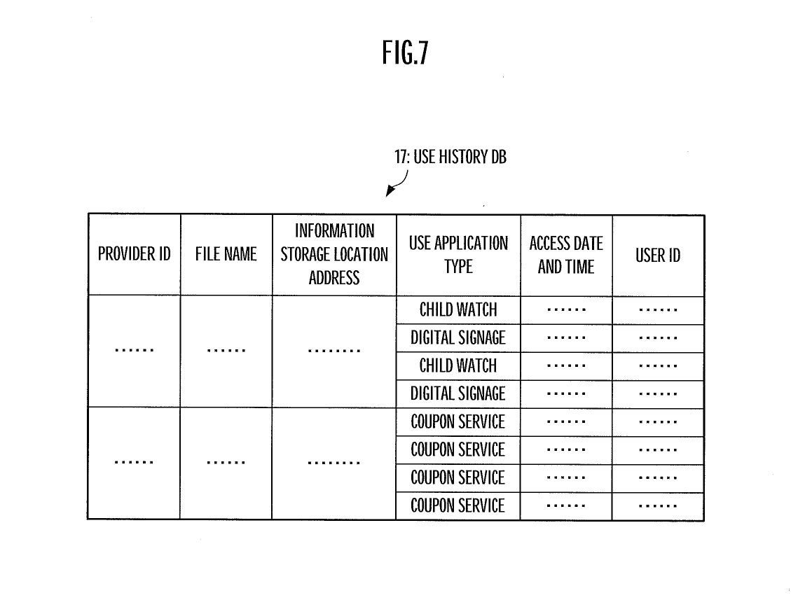

The use history DB 17 is the database in which the use history of information provided by a provider is registered. FIG. 7 is a schematic view illustrating the configuration of the use history DB. The use history DB 17 registers therein a record in which a provider ID, a file name, an information storage location address, a use application type, an access date and time and a user ID are associated with one another.

The use history DB 17 additionally registers therein, whenever a user uses information, with respect to the used information, a use application type, an access date and time, and a user ID. This use history DB 17 is used for calculation of a fee to be paid to a provider corresponding to the use of provided information and for calculation of a fee to be charged to a user in response to the use of the information.

The provision information specifications management table 18 is a table in which, for each of the information provision devices 2, whether or not information provided from the information provision device 2 is appropriate or inappropriate with respect to the specifications of the information registered in the provider contract DB 13 is registered additionally registered. This provision information specifications management table 18 is equivalent to the determination result storage unit defined by the present invention.

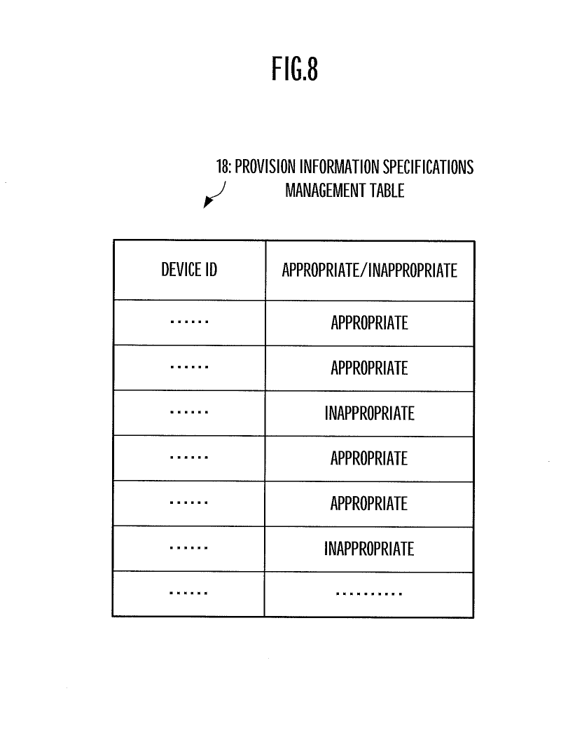

FIG. 8 is a schematic view illustrating a configuration of the provision information specifications management table 18. The provision information specifications management table 18 is, as illustrated in FIG. 8, a table in which, for each of the information provision devices 2 of which the provider contract information is registered in the provider contract DB 13, the device ID and the specifications status (appropriate or inappropriate) are registered in association with each other.

It should be noted that the above described device status registered in the management information DB 15 is information showing whether the information provision device 2 is in operation or in stop and is different from the specifications status set in this provision information specifications management table 18.

It is to be also noted that, in FIG. 3 to FIG. 8, the columns indicated by “ . . . . ” are columns in which an illustration is simply omitted.

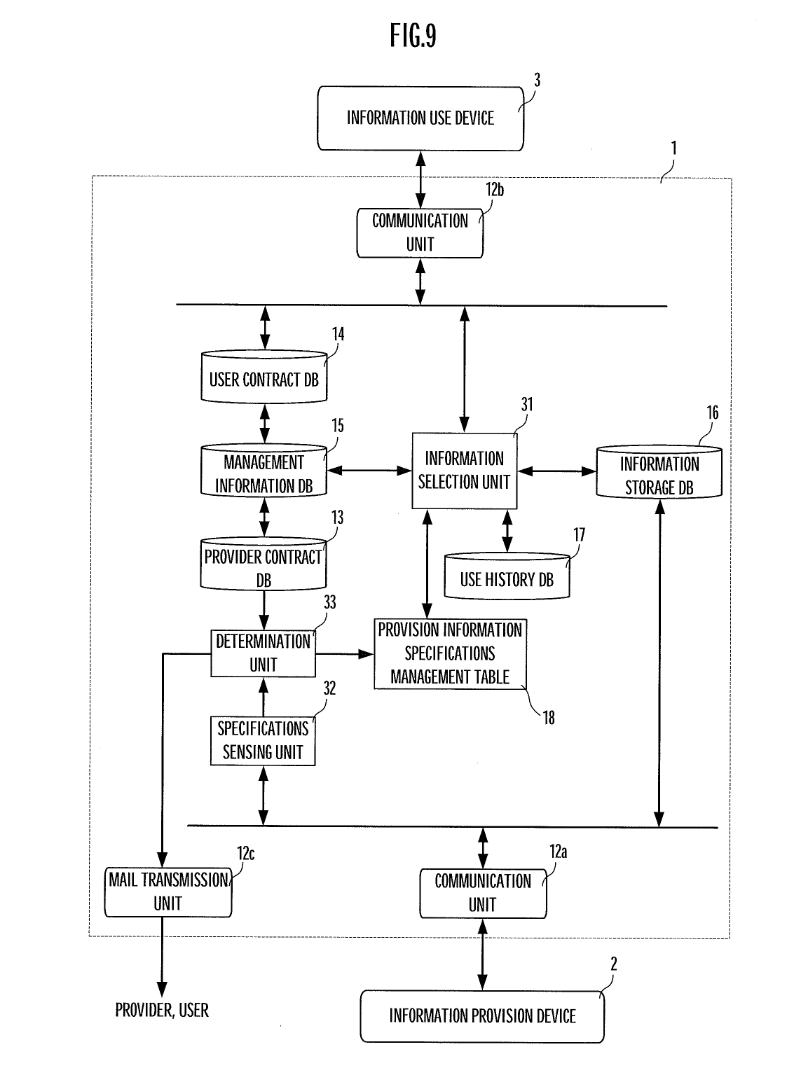

FIG. 9 is a schematic block diagram illustrating a functional configuration of this information management device. In FIG. 9, the configurations illustrated in FIG. 1 and FIG. 2 are denoted by the same reference numerals. The control unit 11 of the information management device 1 has functions of an information selection unit 31, a specifications sensing unit 32, and a determination unit 33.

Communication units 12a and 12b, and a mail transmission unit 12c that are illustrated in FIG. 9 are the configuration concerning the above described communication unit 12. In FIG. 9, the communication unit 12a controls communication with the information provision device 2 and receives information provided from the information provision device 2. Then, the communication unit 12b controls communication with the information use device 3 and transmits information corresponding to a use request of information from the information use device 3. The mail transmission unit 12c transmits email to a provider as a manager/an administrator of the information provision device 2 and to a user who possesses the information use device 3. The destination address of this email may be a maintenance request notification address registered in the provider contract DB 13 and may be a user address registered in the user contract DB 14.

The information selection unit 31 selects information to be transmitted to this information use device corresponding to a use request of information from the information use device 3. The information to be transmitted to the information use device 3 is information provided from the information provision device 2 and is stored in the information storage DB 16. The information selection unit 31 selects information to be transmitted to the information use device 3 using the content of registration of the management information DB 15 and the content of registration of the provision information specifications management table 18.

The specifications sensing unit 32 senses, for each item concerning the specifications of the information registered in the provider contract DB 13, the value of the information provided from the information provision device 2. For example, the specifications sensing unit 32, if the information that has been provided from the information provision device 2 is an image, senses a pixel size (the number of vertical pixels×the number of horizontal pixels) and the number of pixel bits. Likewise, if the information is information provided with temperature measured by a temperature sensor, humidity measured by a humidity sensor, or illuminance measured by an illuminance sensor, the specifications sensing unit 32 senses the number of bits (resolution of a measured value) of temperature data, humidity data, or illuminance data.

The determination unit 33 determines whether or not information provided from the information provision device 2 is appropriate with respect to the specifications of the information registered in the provider contract DB 13. The determination unit 33 updates the provision information specifications management table 18 based on a determination result.

It should be noted that the determination unit, in a case in which the information provided from the information provision device 2 is image data, may preferably compare the provided information and the information (image data) provided from another information provision device that has approximately the same specifications of information and may preferably determine, regarding the specifications such as a light receiving dynamic range width, whether or not the provided information is appropriate.

In addition, the mail transmission unit 12c, in a case in which the determination unit 33 determines that the information provided from the information provision device 2 is inappropriate with respect to the specifications of the information registered in the provider contract DB 13, transmits email to a provider of the information and a user who has used the information to notify the result determined by the determination unit.

Hereinafter, an operation of the information management device 1 in this example will be described.

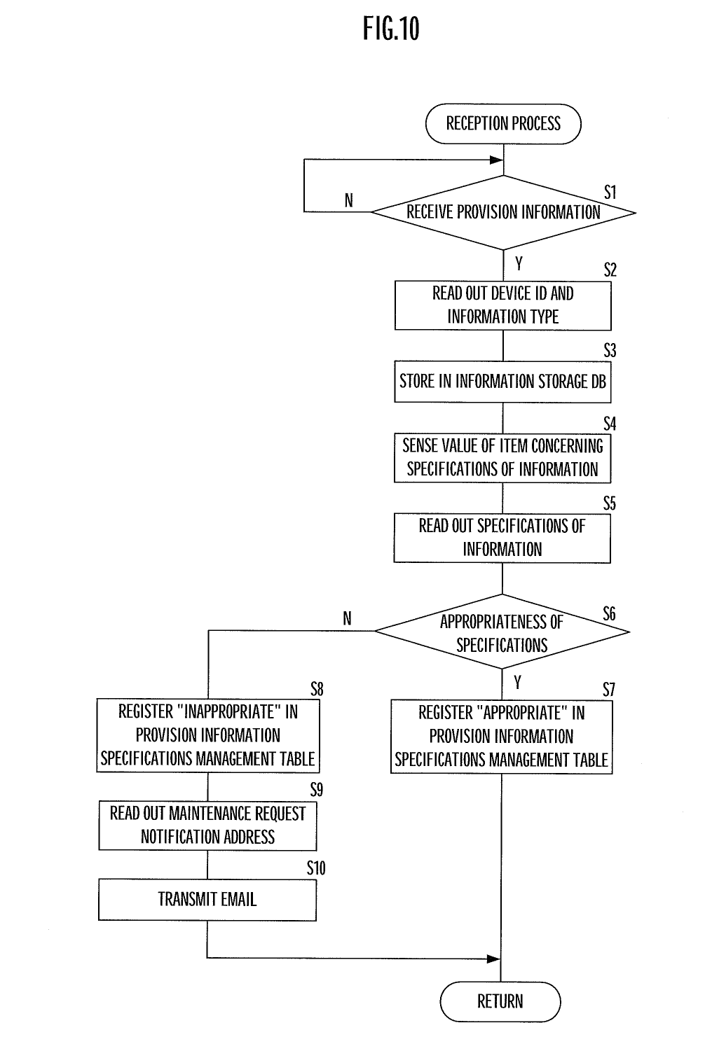

FIG. 10 is a flowchart illustrating a reception process of information provided from the information provision device. The information management device 1 receives, in the communication unit 12a, information (information provided from the information provision device 2) transmitted from the information provision device 2 connected through the network 5. The information provision device 2 transmits the device ID of the own device and the type of information together with information to be provided to the information management device 1.

The information management device 1 receives information transmitted from the information provision device 2 in the communication unit 12a (s1), and then reads out the device ID and the type of information that have been transmitted with this information (s2). The information management device 1 stores the information received this time in the information storage DB 16 based on the device ID and the type of information that have been read out in s2 (s3).

In addition, the information management device 1, in the specifications sensing unit 32, senses, for each item concerning the specifications of the information registered in the provider contract DB 13, the value of the information received this time (s4). As mentioned above, the information management device 1, if the information received this time is image information, senses a pixel size (the number of vertical pixels and the number of horizontal pixels) and the number of pixel bits. Likewise, if the information is information of temperature data, humidity data, or illuminance data, the information management device 1 senses the number of bits (resolution of a measured value) of the data.

The information management device 1, in the determination unit 33, searches the provider contract DB 13 using as a key the device ID and the type of information that have been read out in s2, and then reads out the specifications registered regarding the information received this time (s5).

The information management device 1, in the determination unit 33, compares the value sensed in s4 with the specifications of the information read out in s5 and determines whether or not the information received this time is appropriate with respect to the specifications of the information registered in the provider contract DB 13 (s6). In s6, if the value sensed in s4 is not less than the specifications of the information read in s5 in all the items registered as specifications, the information is determined to be appropriate and if the value sensed in s4 is less than the specifications of the information read out in s5 in any one of the items, the information is determined to be inappropriate.

It should be noted that the processes concerning the above described s4 and s5, in a case in which the information provided from the information provision device 2 is image data, may be configured to compare the provided information and the information (image data) provided from another information provision device 2 that has approximately the same specifications of the registered information and to determine, regarding the specifications such as a light receiving dynamic range width, whether or not the specifications of the provided information are appropriate.

The information management device 1, in s6, registers the determination result of the determination unit 33 in the provision information specifications management table 18 (s7, s8), in s7, sets appropriateness as the present determination result with respect to the relevant device ID, and, in s8, sets inappropriateness as the present determination result with resect to the relevant device ID.

In addition, the information management device 1, when the determination unit 33 determines that the information received this time in s6 is inappropriate with respect to the specifications of the information registered in the provider contract DB 13, searches the provider contract DB 13 using the device ID read out in s2 as a key, and reads out a maintenance request notification address associated with the relevant device ID (s9). The information management device 1, in the mail transmission unit 12c, sets the maintenance request notification address read out in s9 as a destination address, and transmits email to notify that the information being provided is inappropriate with respect to the specifications of the registered information (s10). Moreover, the Information management device 1 maybe configured to search the use history DB 17, extract the information use device 3 that has used the information provided from the information provision device 2 within a fixed period of time (within 24 hours, for example), and to notify, by email addressed to a user address associated with the extracted information use device 3, that the specifications of the provided information have been inappropriate.

It is to be noted that, as described above, every time the information provision device 2 provides information, whether or not the specifications of the information are appropriate is determined, so that a possibility that the information of which the specifications are inappropriate has been provided to the information use device 3 is extremely small.

Thus, when the information being provided from the information provision device 2 is inappropriate for some reason with respect to the specifications of information determined by the provision contract, the status can be promptly notified to a provider. This enables the provider to promptly confirm a reason why the information being provided from the information provision device 2 has becomes inappropriate with respect to the specifications of information determined by the provision contract and deal with the reason. This can prevent information inappropriate with respect to the specifications determined by the provision contract from being kept provided from the information provision device 2.

It should be noted that the determination whether the information being provided from the information provision device 2 is appropriate or inappropriate with respect to the specifications of information determined by the provision contract is not limited to the above example, but may be performed, for example, by comparing with a plurality of pieces of information that has been provided in the past from the information provision device 2 and has been determined to be appropriate with respect to the specifications, or by comparing with a plurality of pieces of information that has been provided from other information provision devices 2 with the same specifications and of which the specifications are determined to be appropriate.

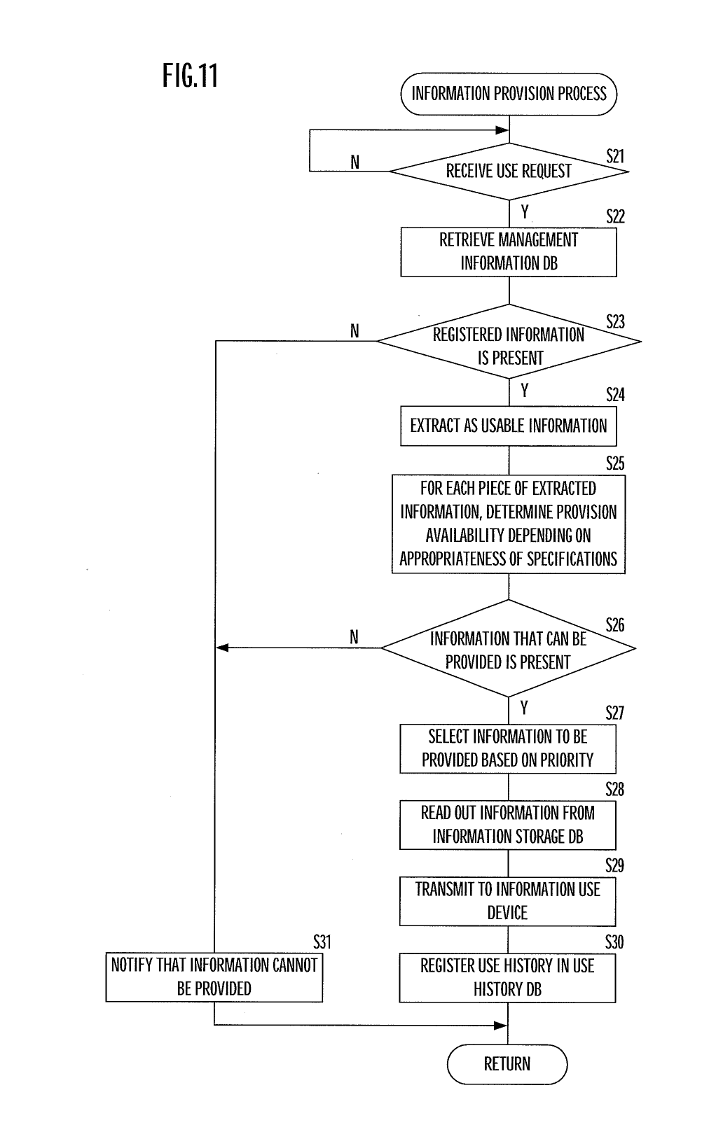

Subsequently, the processes in which information is provided (transmitted) corresponding to a use request of information from the information use device 3 will be described. FIG. 11 is a flowchart illustrating an information provision process in which information is provided to an information use device. The information use device 3 transmits a use request of information including a user ID, a use application type, and an information type desired to be used to the information management device 1.

The information management device 1, in the communication unit 12b, receives a use request of information from the information use device 3 (s21), and then, in the information selection unit 31, searches the management information DB 15 by using the user ID, the use application type, and information type desired to be used that are included in this use request (s22). The information management device 1, if the management information DB 15 has information registered therein in association with a user ID, a use application type, and an information type desired to be used, extracts all the associated information as usable information (s23, s24).

It is to be noted that the information management device 1, if the management information DB 15 has no information registered therein in association with a user ID, a use application type, and an information type desired to be used, notifies the information use device 3 that has transmitted the use request this time that transmission of information cannot be performed (s31), and ends the process.

The information management device 1, in the information selection unit 31, for each piece of information extracted in s24, refers to the provision information specifications management table 18 and determines provision availability of the information by whether the status is appropriate or inappropriate (s25). In s25, performed is a process in which information of which the status is appropriate is determined to be available to be provided and information of which the status is inappropriate is determined to be unavailable to be provided.

The information management device 1, if there is information determined to be available to be provided in s25, based on a priority (cost given priority or specifications given priority) of the information use device 3 that has transmitted the information use request this time, determines information to be provided from among the information determined to be available to be provided in s25 will be determined (s26, s27). In s27, if cost is given priority, information of which the use fee is the lowest is selected among the information determined to be available to be provided in s25; and if specifications are given priority, information of which the specifications value is the highest is selected among the information determined to be available to be provided in s25.

The information management device 1 reads out the information determined in s27 from the information storage DB 16 (s28), and transmits this information to the information use device 3 that has transmitted the use request this time (s29). In addition, the information management device 1 creates use history associated with this transmission of the information to the information use device 3, and registers the use history in the use history DB 17 (s30).

It is to be noted that, if there is no information determined to be available to be provided in s25, notifies the information use device 3 that has transmitted the use request this time that transmission of information cannot be performed (s31), and ends the process. In such a case, the use history of the information is not registered in the use history DB 17.

Thus, this can prevent information of which the specifications are not appropriate from being transmitted to the information use device 3 that has transmitted the use request of information. In other words, this can also prevent the user from making a wrong assessment from a process result obtained by using the information of which the specifications are not appropriate. Accordingly, the reliability of the system according to the preferred embodiment from the perspective of a user who uses information can be improved.

Moreover, in the above example, in a case in which there are a plurality of pieces of information determined to be available to be provided in s25, based on a priority (cost given priority or specifications given priority), a single piece of information is selected and transmitted to the information use device 3, but all pieces of information determined to be available to be provided in s25 may be transmitted to the information use device 3.

Subsequently, description will be made of another preferred embodiment of the present invention. The network system according to this preferred embodiment also has the configuration illustrated in FIG. 1. Also in this preferred embodiment, the provision contract is exchanged with a provider and the use contract is exchanged with a user.

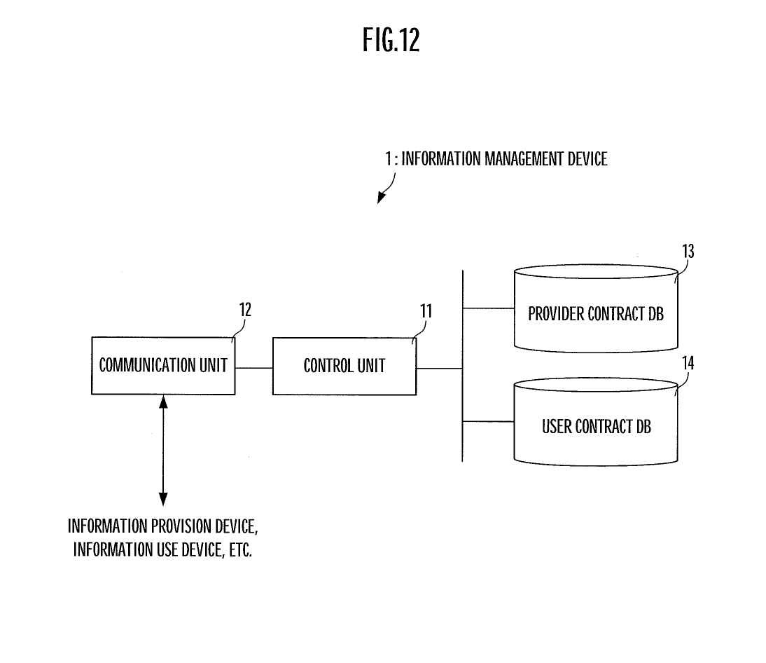

FIG. 12 is a block diagram illustrating a configuration of a main part of an information management device according to this example of the present invention. In FIG. 12, the configuration similar to the configuration illustrated in FIG. 2 is denoted by the same reference numerals. The information management device 1 is equipped with a control unit 11, a communication unit 12, a provider contract database 13 (provider contract DB 13), and a user contract database 14 (user contract DB 14).

The control unit 11 controls the operation of the main body of the information management device 1.

The communication unit 12 performs communication between various devices connected through a network 5 including an information provision device 2 and an information use device 3.

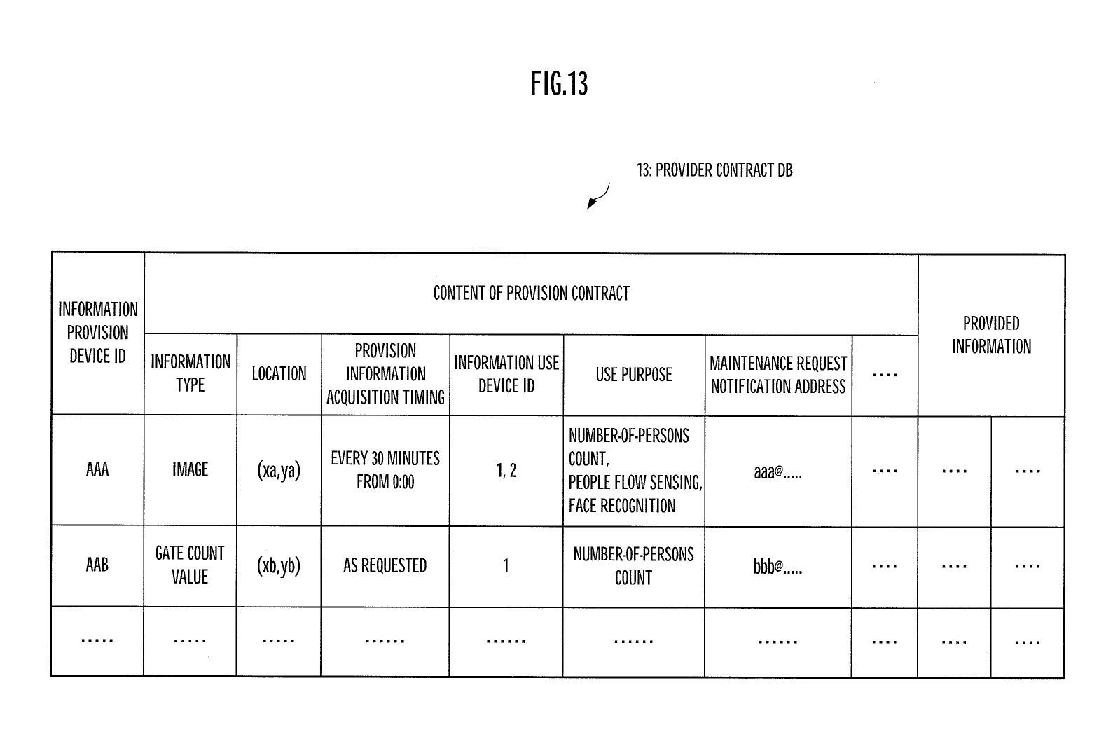

The provider contract DB 13, for each of the information provision devices 2, registers and stores therein the content of the contract concerning a provision of information exchanged with a provider, actually provided information, and the like. FIG. 13 is a schematic view illustrating a configuration of the provider contract DB 13 according to this example of the present invention. The provider contract DB 13 registers therein, for each of the information provision devices 2, an information provision device ID, the content of a provision contract, and provided information that are associated with one another. The information provision device ID is an identification code that identifies an information provision device 2 that has exchanged a provision contract.

The content of a provision contract includes an information type, a location, a provision information acquisition timing, an information use device ID, a use purpose, and a maintenance request notification address. The information type is a type of the information provided by the information provision device 2, an imaged image, a gate count value, temperature, and the like. The location shows a place in which the information that the information provision device 2 provides is acquired. For example, latitude and longitude show a place in which provision information is acquired. The provision information acquisition timing indicates a timing when the information that the information provision device 2 provides is acquired. For example, if information is an imaged image, the imaging timing of the imaged image and the like are indicated. The information use device ID is an identification code that identifies the information use device 3 using the information that the information provision device 2 provides. The use purpose is a use purpose of the information in the information use device 3. The maintenance request notification address is a mail address of a provider.

In this example, the information provided from the information provision device 2 is stored in the provider contract DB 13.

It should be noted that this provider contract DB 13 may be configured to divide the above described items into a plurality of databases. The content of a provision contract includes a sampling period and an output speed as specifications of information.

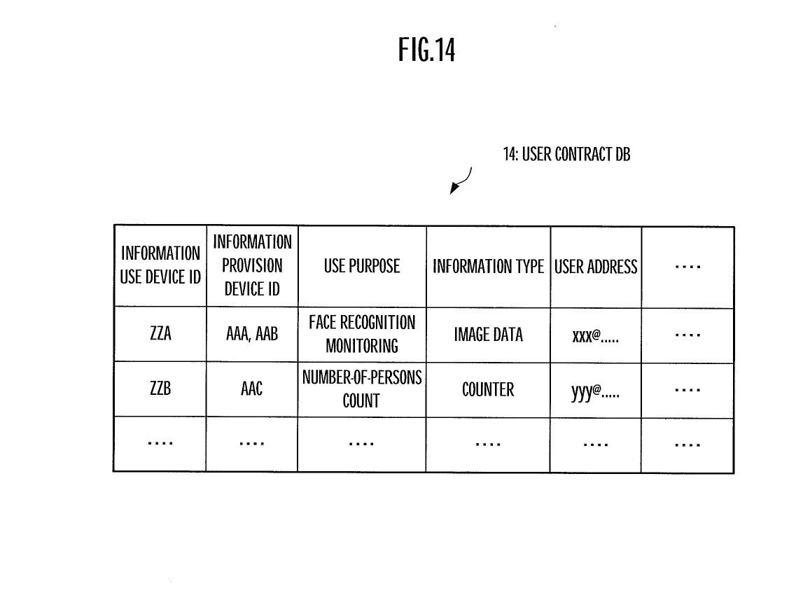

The user contract DB 14 registers and stores therein, for each of the information use devices 3, the content of a contract concerning a provision of use information exchanged with a user and the like. FIG. 14 is a schematic view illustrating a configuration of the user contract DB 14 according to this example of the present invention. The user contract DB 14 registers therein, for each of the information use devices 3, an information use device ID, an information provision device ID, a use purpose, an information type, a user address, and the like as the content of a use contract. The information use device ID is an identification code that identifies an information use device 3 that has exchanged a use contract. The information provision device ID is an identification code that identifies the information provision device 2 that provides information used in the information use device 3. The use purpose indicates a purpose to use information. The use information type shows a type of the information used in the information use device 3. The user address is a mail address of the user who possesses the information use device 3.

The use contract information includes a sampling period and an output speed as the specifications of information to be used.

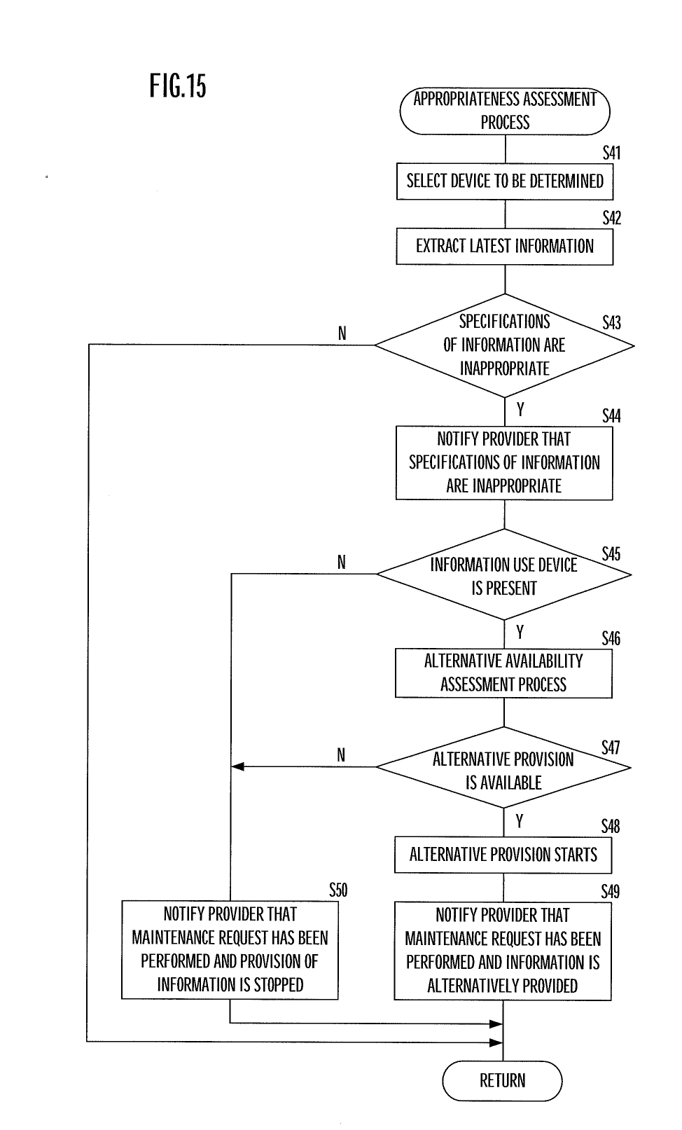

FIG. 15 is a flowchart illustrating a process in which the information management device assesses whether or not the specifications of information being provided from the information provision device are appropriate or inappropriate (appropriateness assessment process).

The information management device 1, from among the information provision device 2 that provides information, selects the information provision device 2 (device to be determined) as an object to be assessed whether the information being provided is appropriate or inappropriate (s41). In s41, the information provision devices 2 that have exchanged the provision contract may be selected in a sequential order as a device to be determined, or may be selected as a device to be determined based on predetermined certain standards.

The information management device 1 extracts the latest information being provided at the present time from the device to be determined (information provision device 2) selected in s41 (s42). For each of the information provision devices 2, the information provided from the information provision device 2 is stored in the provider contract DB 13. In s42, the information management device 1 searches the provider contract DB 13 and extracts the latest information provided from this information provision device 2.

The information management device 1 determines whether the specifications of the information extracted in s42 are appropriate or inappropriate (s43). Herein, appropriate specifications of information mean that the specifications of information are appropriate with respect to the content of a provision contract exchanged with a provider. That is, in s43, the limited determination of whether abnormalities such as a failure occur in the information provision device 2 that provides information is not performed. Specifically, in s43, the assessment of the following (a) to (d) is performed and whether the specifications of provided information are appropriate or inappropriate is assessed.

(a) The presence or absence of a failure with respect to the information provision device 2 that provides the information is inquired and, by the response from the relevant information provision device 2, whether the specifications of information are appropriate or inappropriate (presence or absence of a failure in the information provision device 2) is assessed.

(b) The information being provided from the information provision device 2 that provides the information is monitored and compared with information that has been provided beforehand, and whether the specifications of the information are appropriate or inappropriate is assessed by the size of the difference.

(c) At a location comparatively close to a location in which information being provided from the information provision devices 2 is acquired, the information is compared with information being provided from another information provision device 2 that acquires the same type of information, and whether the specifications of the information are appropriate or inappropriate is assessed by the size of the difference.

(d) With respect to the content of a contract, whether the specifications of the information are appropriate or inappropriate is assessed by whether or not a part of the items of the provided information is defective or missing.

The information management device 1, when assessing the specifications of the provided information are appropriate in the assessment of all of the above (a) to (d), assesses that the specifications of the information are appropriate. In other words, in the assessment of any one of the above (a) to (d), when the specifications of the provided information are assessed not to be appropriate, the specifications of the information are assessed inappropriate.

It should be noted that items that cannot be assessed concerning the above (a) to (d) due to a type of information, a peripheral environment, or the like may not be utilized for assessment of whether the specifications of the information are appropriate or inappropriate. In addition, assessment criteria other than the above (a) to (d) are established and whether the specifications of the information are appropriate or inappropriate may be assessed.

The information management device 1, when assessing that the specifications of the information is appropriate in s43, returns to s41 and repeats the above processes.

The information management device 1, when assessing that the specifications of the information are inappropriate in s43, issues a maintenance request to transmit notification that the specifications of the information are inappropriate to the provider of the information provision device 2 that provides the information (s44). In s44, the maintenance request notification address of the relevant provider who has been registered in the provider contract DB 13 is set as a destination address, and this notification is transmitted by email. Transmission of email is performed in the communication unit 12.

The information management device 1 assesses the presence or absence of the information use device 3 that uses the information determined to be inappropriate this time (s45). The information management device 1, when assessing that there is no information use device 3 that uses the information in s45, returns to s41 and repeats the above processes.

The information management device 1, when assessing that there are information use devices 3 that use the information in s45, performs an alternative availability assessment process of assessing whether the information being provided from other information provision devices 2 may be provided to these information use devices 3 (s46).

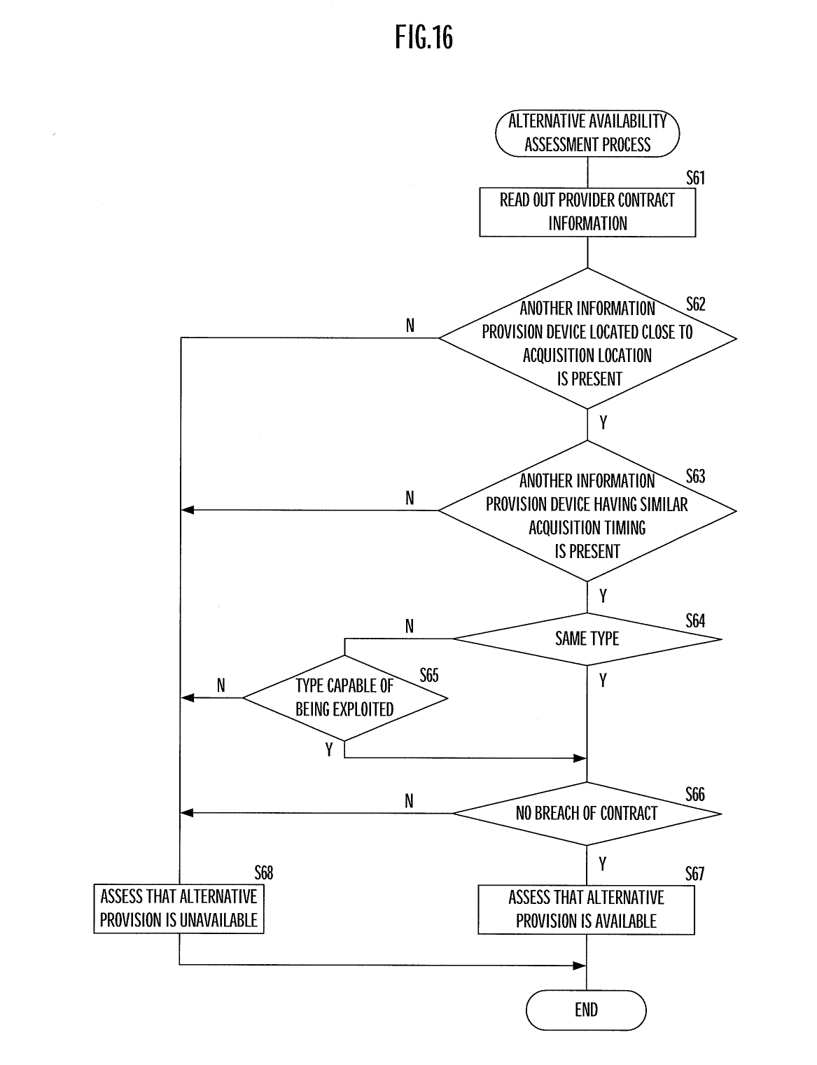

FIG. 16 is a flowchart illustrating an alternative availability assessment process in s46.

The information management device 1 reads out from the provider contract DB 13 the provider contract information concerning the information provision device 2 that has assessed that the specifications of information are inappropriate this time (s61). The information management device 1 retrieves whether or not there are other information provision devices 2 in the contract on the condition that the provider contract information read out in s61 is covered.

To begin with, the information management device 1, in s62, searches other information provision devices 2 of which locations are comparatively close to the location in which the provided information is acquired. Subsequently, the information management device 1 retrieves, among the other information provision devices 2 searched in s62, the information provision devices 2 of which the information acquisition timings are approximately the same (s63). The information management device 1, if no other information provision devices 2 are retrieved in s62 or s63, assesses that alternative provision of use information is unavailable in s68.

The information management device 1, when one or more other information provision devices 2 can be searched in s63, among these information provision devices 2, searches the information provision device 2 that provides the information of the same type as the type of the information of which the specifications have been assessed inappropriate this time (s64). The information management device 1, in s64, if no other information provision devices 2 are retrieved, among the other information provision devices 2 searched in s63, searches the information provision devices 2 that provide a type of information capable of being exploited as information of which the specifications have been assessed inappropriate this time (s65). The availability of exploitation between the types of information may be registered in the information management device 1 in advance.

The information management device 1, if no other information provision devices 2 are retrieved in s65, assesses that alternative provision of use information is unavailable in s68.

The information management device 1, based on the provision contract information of the other information provision devices 2 that have been acquired by the search in s64 or s65, and the use contract information of the information use device 3 that has provided the information of which the specifications have been assessed to be inappropriate this time, assesses whether or not alternative provision is available without being the breach of the contract (s66). In s66, for example, the contract in which the output speed of information of the other information provision devices 2 is not less than 60 pps and the provision speed of information of the information use device 3 is not less than 40 pps is not assessed to be the breach of the contract. On the other hand, for example, the contract in which the output speed of information of the other information provision devices 2 is not less than 40 pps and the provision speed of information of the information use device 3 is not less than 60 pps is assessed to be the breach of the contract.

The attribute of information is designated respectively by a provider and a user at the time of the contract. The attribute includes, besides the above attributes, a data use fee, data reliability, a dynamic range, and linearity.

The information management device 1, when assessing the contract is not breached in s66, assesses the alternative provision of information is available (s67). In contrast, the information management device 1, when assessing the contract is breached in s66, assesses the alternative provision of information is unavailable in s68.

Reference is returned to FIG. 15 to continue description. The information management device 1, in the alternative availability assessment process (process illustrated in FIG. 16) concerning s46, assesses that the alternative provision of information is available (s47) and starts the alternative provision of information (s48). The information management device 1 also transmits notification that the maintenance request has been given to the provider and that the information is alternatively provided, to the user who possesses the information use device 3 using the relevant information (s49).

On the other hand, the information management device 1, in the alternative availability assessment process concerning s46, assesses that the alternative provision of information is unavailable (s47) and transmits notification that the maintenance request has been given to the provider and that the provision of use information has stopped, to the user who possesses the information use device 3 using the relevant information (s50). In s49 and s50, the mail address of the relevant user who has been registered in the user contract DB 14 is set as a destination address, and this notification is transmitted by email. Transmission of email is performed in the communication unit 12.

In this way, the information management device 1 automatically assesses a state in which the specifications of the information being provided from any one of the information provision devices 2 become inappropriate for some reason, and notifies the provider of the relevant information provision device 2 of the state. Thus, the burden (such as the burden of confirming whether or not the specifications of the information being used are appropriate, and the burden concerning a maintenance request when the specifications are inappropriate) of the user who possesses the information use device 3 that uses the information can be reduced.

In addition, to the provider of the information provision device 2, the notification that the specifications of the information being provided become inappropriate can be promptly transmitted, which makes it possible to promptly deal with the inappropriate status. Therefore, a time period when appropriate information is not being provided to the information use device 3 can be restrained from becoming uselessly longer.

Moreover, the information management device 1 also notifies, with respect to a user who possesses the information use device 3, that the information is alternatively provided, that the provision of information is stopped, or the like, so that the user can also easily grasp the status of the system.

Furthermore, since the information management device 1 searches other information provision devices 2 alternative to the information provision device 2 of which the specifications of the information being provided are inappropriate, and provides, as alternative information, the information being provided from the information provision device 2 that has been searched to the information use device 3, so that the occurrence frequency of the situation in which the process on the side of the information use device 3 stops can be also restrained.

Alternatively, in a case in which there are a plurality of information provision devices 2 that provide information capable of being alternatively provided in s47, the information provision devices 2 may be configured to contact a user to ask from which information provision device 2 information being provided should be alternatively provided.

Moreover, in s66, not only the contract conditions but also the administration rules of the network system according to the preferred embodiment, and the like are decided, and the alternative availability of information may also be assessed based on this administration rules.

Furthermore, in a case in which a provider cannot provide information, measures against the provider may be taken, the measures making the provider unable to receive consideration associated with use of the information. In addition, if the information provision device 2 is an information provision device 2 equipped with a PTZ camera capable of automatically changing a photographing condition, information in the form of an equation or the like can be provided in order to meet the request from a plurality of users.

### REFERENCE SIGNS LIST

1 Information management device
2 Information provision device
3 Information use device
5 Network
11 Control unit
12 Communication unit
12a Communication unit
12b Communication unit
12c Mail transmission unit
13 Provider contract DB (provider contract database)
14 User contract DB (user contract database)
15 Management information DB (management information database)
16 Information storage DB (information storage database)
17 Use history DB (use history database)
18 Provision information specifications management table
31 Information selection unit
32 Specifications sensing unit
33 Determination unit

1.-7. (canceled)

8. An information management device comprising:
a provision information storage unit that stores sensing data provided from an information provision device connected in a communicable manner through a network;
an information selection unit that, when receiving a use request of the sensing data from an information use device connected in a communicable manner through the network, selects the sensing data corresponding to the use request from the sensing data stored in the provision information storage unit;
a determination unit that determines whether or not the sensing data provided from the information provision device is appropriate with respect to specifications predetermined for the sensing data;
a determination result storage unit that stores a determination result of the determination unit;
a provision contract information storage unit that stores provision contract information that indicates content of a provision contract including at least a sensing range and a type of the sensing data to be provided, the provision contract being exchanged regarding use of the sensing data to be provided from the information provision device; and
a use contract information storage unit that stores use contract information that indicates content of a use contract including at least a sensing range and a type of the sensing data to be used, the use contract being exchanged regarding use of the sensing data in the information use device,
wherein the information selection unit, by using the provision contract information and the use contract information, selects the sensing data corresponding to a received use request, and does not select, as the sensing data corresponding to the use request, the sensing data of which the determination result is stored in the determination result storage unit as inappropriate with respect to predetermined specifications.

9. An information management program that causes a computer to execute steps comprising:
a provision information storage step of storing, in a provision information storage unit, sensing data provided from an information provision device connected in a communicable manner through a network;
an information selection step of, when receiving a use request of the sensing data from an information use device connected in a communicable manner through the network, selecting the sensing data corresponding to the use request from the sensing data stored in the provision information storage unit;
a determination step of determining whether or not the sensing data provided from the information provision device is appropriate with respect to specifications predetermined for the sensing data; and
a determination result storage step of storing, in a determination result storage unit, a determination result of the determination unit,
wherein the information selection step is a step in which, by using provision contract information that indicates content of a provision contract including at least a sensing range and a type of the sensing data to be provided, the provision contract being exchanged regarding use of the sensing data to be provided from the information provision device and being stored in a provision contract information storage unit and use contract information that indicates content of a use contract including at least a sensing range and a type of the sensing data to be used, the use contract being exchanged regarding the use of the sensing data in the information use device and being stored in a use contract information storage unit, the sensing data corresponding to a received use request is selected and the sensing data of which the determination result is stored in the determination result storage unit as inappropriate with respect to predetermined specifications is not selected as the sensing data corresponding to the use request.

10. An information management method executed by a computer, the method comprising:
a provision information storage step of storing, in a provision information storage unit, sensing data provided from an information provision device connected in a communicable manner through a network;
an information selection step of, when receiving a use request of sensing data from an information use device connected in a communicable manner through the network, selecting the sensing data corresponding to the use request from the sensing data stored in the provision information storage unit;
a determination step of determining whether or not the sensing data provided from the information provision device is appropriate with respect to specifications predetermined for the sensing data; and
a determination result storage step of storing, in a determination result storage unit, a determination result of the determination step,
wherein the information selection step is a step in which, by using provision contract information that indicates content of a provision contract including at least a sensing range and a type of the sensing data to be provided, the provision contract being exchanged regarding use of the sensing data to be provided from the information provision device and being stored in a provision contract information storage unit and use contract information that indicates content of a use contract including at least a sensing range and a type of the sensing data to be used, the use contract being exchanged regarding the use of the sensing data in the information use device and being stored in a use contract information storage unit, the sensing data corresponding to a received use request is selected and the sensing data of which the determination result is stored in the determination result storage unit as inappropriate with respect to predetermined specifications is not selected as the sensing data corresponding to the use request.
